(19) United States
(12) Patent Application Publication
(10) Pub. No.: US 2007/0266568 A1
(43) Pub. Date: Nov. 22, 2007

(54) Pruning clipper

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/584,579

(22) Filed: Oct. 23, 2006

(30) Foreign Application Priority Data
May 16, 2006 (TW) 95208366

(51) Int. Cl. B25F 3/00; B26B 1/00

(52) U.S. Cl. 30/134

(57) ABSTRACT

A pruning clipper includes a first clipper member having a stop edge, a second clipper member pivoted to the first clipper member and provided with a through hole, and a first adjustment member having a pivot pin pivotally inserted into the through hole of the second clipper member, and a stop rod connected to the pivot pin and turnable with the pivot pin between a first position where the stop rod is disengaged with the stop edge of the first clipper member and a second position where the stop rod is stopped at the stop edge of the first clipper member to limit the open angle between the first and second clipper members.

### BACKGROUND OF THE INVENTION

1. Field of the Invention

The present invention relates to a pruning clipper and more particularly, to a simple structure of pruning clipper, which allows adjustment of the open angle of the cutting mouth.

2. Description of the Related Art

Taiwan Patent Publication No. 00365110 discloses a cutting mouth adjustable pruning clipper. According to this design, the pruning clipper comprises a first blade, a second blade, a first grip, a second grip, a slidable push button, and a spring member. The first blade has a retaining groove. The first blade and the second blade define a cutting mouth. The slidable push button is slidably coupled to a rail at the second grip. The spring member supports the first blade and the second blade to open the cutting mouth. When the user operates the pruning clipper to open the cutting mouth after the user has pushed the slidable push button to the topmost end of the rail, the slidable push button will be forced into a notch at the first blade to limit the opening angle of the cutting mouth. This design of cutting mouth adjustable pruning clipper is functional; however, the rail and the slidable push button have a complicated structure, resulting in a high manufacturing cost.

### SUMMARY OF THE INVENTION

The present invention has been accomplished under the circumstances in view. It is therefore an objective of the present invention to provide a pruning clipper, which allows adjustment of the open angle of the cutting mouth.

It is another objective of the present invention to provide a pruning clipper, which is easy and inexpensive to manufacture.

To achieve these objectives of the present invention, the pruning clipper provided by the present invention comprises a first clipper member, a second clipper member, and a first adjustment member. The first clipper member has a stop edge. The second clipper member is pivoted to the first clipper member and provided with a through hole. The first adjustment member has a pivot pin pivotally inserted into the through hole of the second clipper member, and a stop rod connected to an end of the pivot pin and turnable with the pivot pin between a first position where the stop rod is not stopped at the stop edge of the first clipper member and a second position where the stop rod is stopped at the stop edge of the first clipper member to limit the open angle between the first and second clipper members.

In a preferred embodiment of the present invention, the second clipper member is provided with a positioning groove defining a relatively narrower close end and a relatively wider open end. A second adjustment member having a base block and a retaining portion extending from the base block is moveably mounted on the first clipper member. The second adjustment member is movable relative to the first clipper member between a third position where the retaining portion thereof is located at the open end of the positioning groove such that the first clipper member is pivotable relative to the second clipper member and a fourth position where the retaining portion is engaged into the close end of the positioning groove such that the first clipper member is locked to the second clipper member.

Further, the second clipper member is provided with two recessed holes. A switch button is fastened to the other end of the pivot pin opposite to the stop rod for operation by the user to turn the stop rod. The switch button is provided with a protrusion selectively engageable into one of the two recessed holes of the second clipper member to lock the stop rod in one of the aforesaid first position and second position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a pruning clipper according to a preferred embodiment of the present invention;

FIG. 2 is a bottom view of the pruning clipper according to the preferred embodiment of the present invention;

FIG. 3 is an exploded view of the pruning clipper according to the preferred embodiment of the present invention;

FIG. 4 is a partial cutaway view of the preferred embodiment of the present invention;

FIG. 5 is similar to FIG. 4, but showing the full open status of the cutting mouth;

FIG. 6 is similar to FIG. 4, but showing the half open status of the cutting mouth, and

FIG. 7 is similar to FIG. 4, but showing the cutting mouth is fully closed.

### DETAILED DESCRIPTION OF THE INVENTION

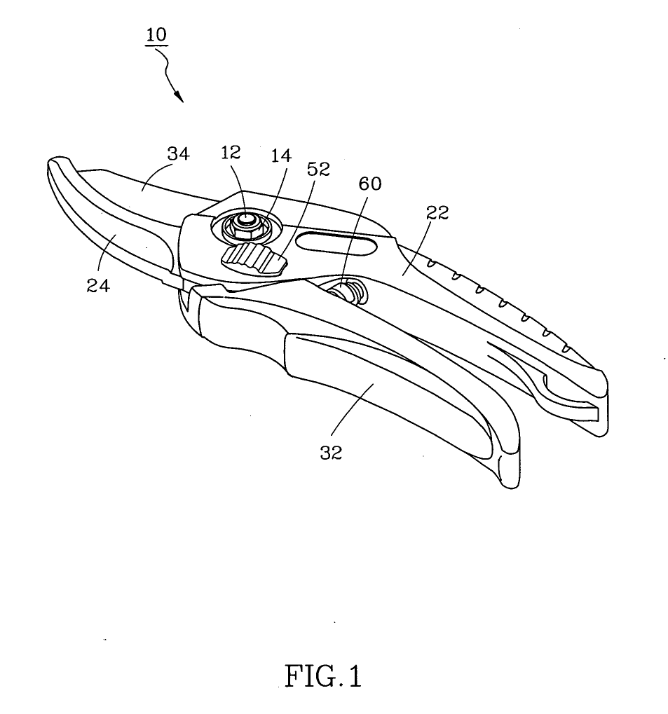

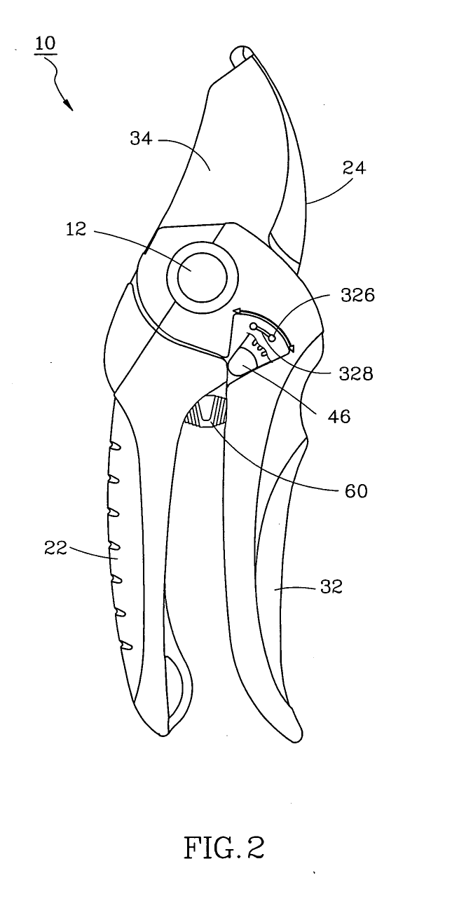

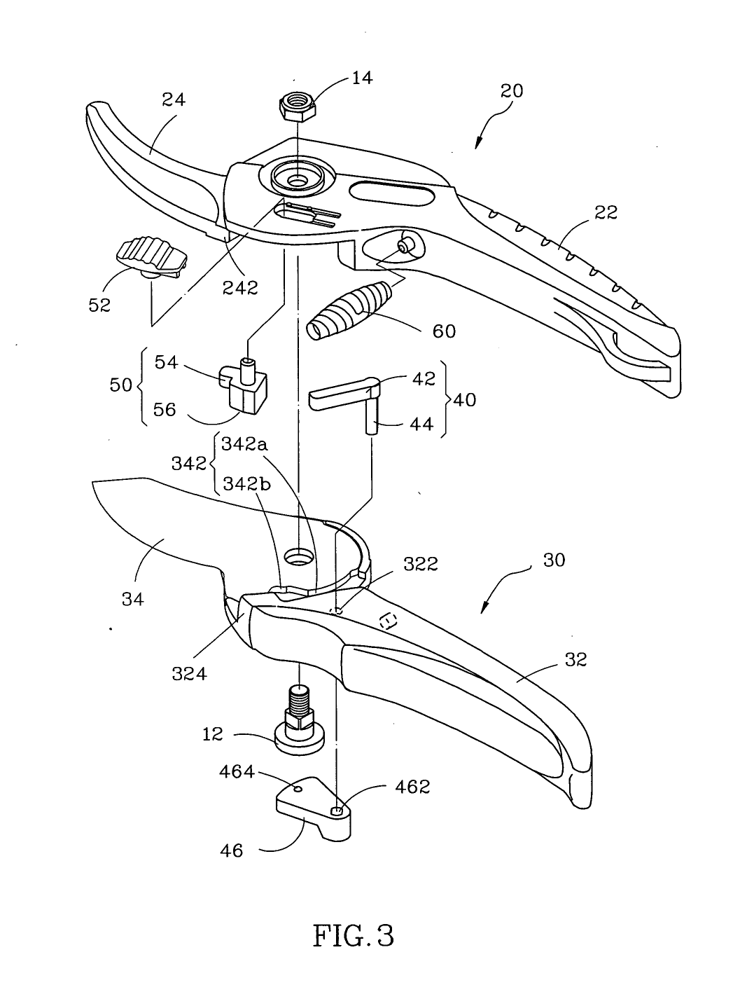

As shown in FIGS. 1-3, a pruning clipper 10 in accordance with a preferred embodiment of the present invention comprises of a first clipper member 20, a second clipper member 30, a first adjustment member 40, a second adjustment member 50, and a spring member 60.

The first clipper member 20 has a grip 22 and a blade 24 mounted on one end of the grip 22. The blade 24 has a stop edge 242 adjacent to the end edge of the grip 22, and a positioning groove 244.

The second clipper member 30 is pivotally coupled to the first clipper member 20 with a screw bolt 12 and a nut 14. The second clipper has a grip 32 and a blade 34 mounted on end of the grip 32. The grip 32 has a circular through hole 322, a stop edge 324 adjacent to the blade 34, two recessed holes 326 on the outer side thereof, and a guide groove 328 connected between the two recessed holes 326. The blade 34 has a positioning groove 342, which has an open end 324a and a close end 342b. The width of the positioning groove 342 is made gradually increased in direction from the close end 342b toward the open end 342a. Further, the blade 24 of the first clipper member 20 defines with the blade 34 of the second clipper member 30 a cutting mouth 16.

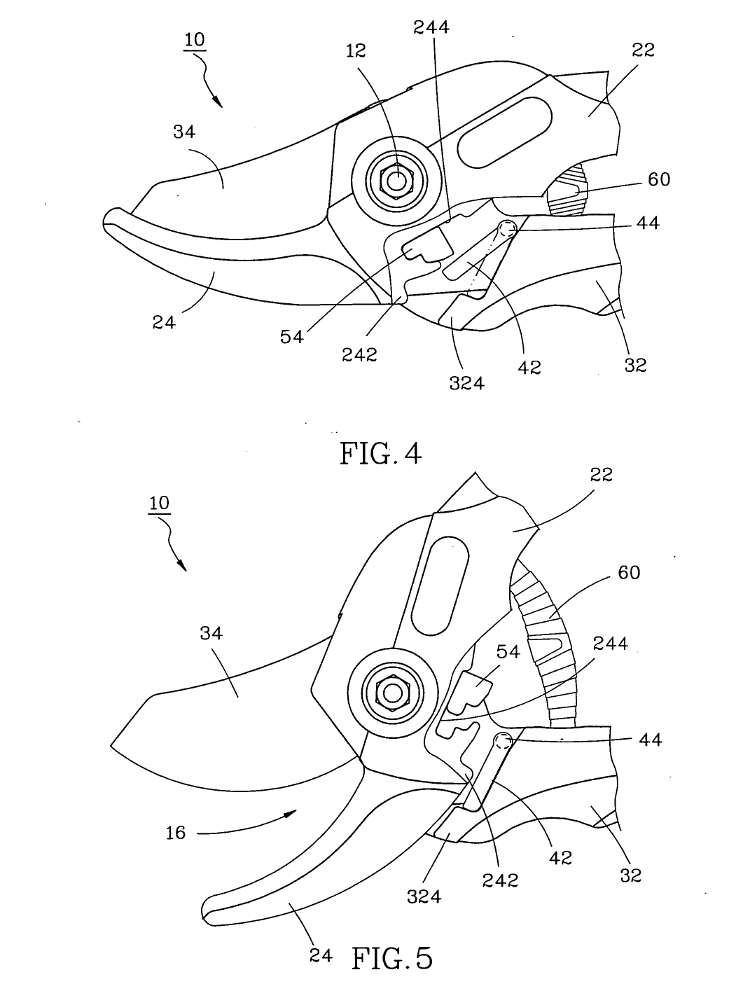

The first adjustment member 40 comprises a stop rod 42 and a non-circular pivot pin 44 extending from one end of the stop rod 42. The pivot pin 44 is inserted through the circular through hole 322 of the grip 32 of the second clipper member 30, for enabling the stop rod 42 to be moved between a first position (see the imaginary line in FIG. 4) and a second position (see the real line in FIG. 4). After insertion through the circular through hole 322 of the grip 32 of the second clipper member 30, the pivot pin 44 is fixedly inserted into a hole 462 of a switch button 46. The user can push the switch button 46 to move the stop rod 42 between the first position and the second position. The switch button 46 has a protrusion 464 at the inner side. The shape and size of the protrusion 464 fit the shape and size of the recessed holes 326 of the grip 32 of the second clipper member 30. The protrusion 464 can be selectively engaged in one of the two recessed holes 326 to hold the stop rod 42 in the first or second position. The guide groove 328 is adapted to guide movement of the protrusion 464 between the two recessed holes 326.

The second adjustment member 50 is movably coupled to the grip 22 of the first clipper member 20 by means of a push button 52. The second adjustment member 50 has a base block 54 and a retaining portion 56 protruding from a side of the base block 54. The base block 54 is accommodated in the positioning groove 244 of the first clipper member 20. The retaining portion 56 is received in the positioning groove 342 of the second clipper member 30. The shape and size of the retaining portion 56 fit the close end 342b of the positioning groove 342. Further, the user can push the push button 52 to move the second adjustment member 50 between a third position (see the imaginary line in FIG. 7) and a fourth position (see the real line in FIG. 7). When the second adjustment member 50 is in the fourth position, the retaining portion 56 is set in the close end 342b of the positioning groove 342.

The spring member 60 is connected between the grip 22 of the first clipper member 20 and the grip 32 of the second clipper member 30, forcing the first clipper member 20 and the second clipper member 30 to open the cutting mouth 16.

Referring to FIG. 5, when the stop rod 42 is in the first position, the spring force of the spring member 60 forces the first clipper member 20 and the second clipper member 30 to open the cutting mouth 16 to the maximum angle. At this time, the blade 24 of the first clipper member 20 is stopped at the stop edge 324 of the grip 32 of the second clipper member 30.

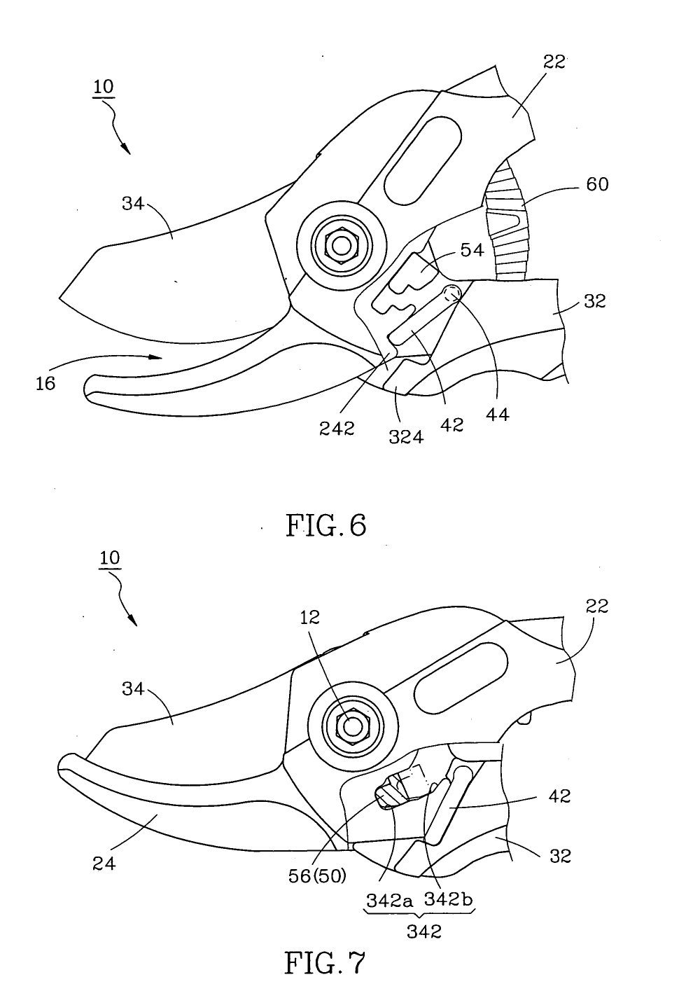

Referring to FIG. 6, when the stop rod 42 is moved to the second position, the stop rod 42 is stopped with the end edge thereof against the stop edge 242 of the blade 24 of the first clipper member 20, preventing further movement between the first clipper member 20 and the second clipper member 30 to expand the cutting mouth 16 to the maximum angle, and therefore the open angle of the cutting mouth 16 is limited.

Because of simple structure, the first adjustment member 40 is easy and inexpensive to manufacture.

Further, the pruning clipper 10 provides a locking function. When the second adjustment member 50 is in the fourth position, as shown in FIG. 7 (the real line position), the retaining portion 56 is set in the close end 342b of the positioning groove 342 of the blade 34 of the second clipper member 30. Because the close end 342b has a relatively smaller space, the retaining portion 56 cannot be turned about the screw bolt 12, and therefore the first clipper member 20 and the second clipper member 30 are locked, keeping the cutting mouth 16 closed. On the contrary, when the second adjustment member 50 is in the third position, the positioning groove 342 provides a sufficient space for allowing the retaining portion 56 to be turned about the screw bolt 12, i.e., the first clipper member 20 and the second clipper member 30 are unlocked and movable relative to each other to cut grass, twigs, flower, etc. The base block 54 of the second adjustment member 50 is positioned in the positioning groove 244 of the blade 24 of the first clipper member 20 to prohibit movement of the second adjustment member 50 relative to the blade 24 of the first clipper member 20. In case the second adjustment member 50 is biased relative to the blade 24 of the first clipper member 20, the retaining portion 56 of the second adjustment member 50 will not be smoothly engaged into the close end 342b of the positioning groove 342.

Although a particular embodiment of the invention has been described in detail for purposes of illustration, various modifications and enhancements may be made without departing from the spirit and scope of the invention. For example, the first adjustment member 40 can be installed in the blade 24 of the first clipper member 20; the first adjustment member 40 may be variously shaped. Accordingly, the invention is not to be limited except as by the appended claims.

What is claimed is:

1. A pruning clipper comprising:
a first clipper member having a stop edge;
a second clipper member pivoted to the first clipper member, the second clipper member having a through hole; and
a first adjustment member having a pivot pin pivotally inserted into the through hole of the second clipper member, and a stop rod connected to the pivot pin and turnable with the pivot pin between a first position where the stop rod is not stopped at the stop edge of the first clipper member and a second position where the stop rod is stopped at the stop edge of the first clipper member.

2. The pruning clipper as claimed in claim 1, wherein the second clipper member has a positioning groove with a relatively narrower close end and a relatively wider open end; the pruning clipper further comprising a second adjustment member having a base block moveably mounted on the first clipper member and a retaining portion extending from the base block; wherein the retaining portion of the second adjustment member has a shape and size fitting tightly the shape and size of the close end of the positioning groove of the second clipper member and the second adjustment member is movable relative to the first clipper member between a third position where the retaining portion is located at the open end of the positioning groove and a fourth position where the retaining portion is engaged into the close end of the positioning groove.

3. The pruning clipper as claimed in claim 1, further comprising a spring member connected between said first clipper member and said second clipper member.

4. The pruning clipper as claimed in claim 1, wherein the second clipper member has two recessed holes; the pruning clipper further comprising a switch button fastened to one end of the pivot pin opposite to the stop rod for operation by the user to turn the stop rod between said first position and said second position, wherein the switch button having a protrusion selectively engageable into one of said two recessed holes of the second clipper member to lock the stop rod in one of said first position and said second position.
